(19) United States
(12) Patent Application Publication
(10) Pub. No.: US 2021/0274937 A1
(43) Pub. Date: Sep. 9, 2021

(54) SOLAR POWERED CHAISE LOUNGE

(71) Applicants: Keith Goldstein, Virginia Beach, VA (US); Phillip Goldstein, Virginia Beach, VA (US)

(72) Inventors: Keith Goldstein, Virginia Beach, VA (US); Phillip Goldstein, Virginia Beach, VA (US)

(21) Appl. No.: 17/189,791

(22) Filed: Mar. 2, 2021

Related U.S. Application Data
(60) Provisional application No. 62/984,606, filed on Mar. 3, 2020.

(51) Int. Cl. A47C 1/024; A47C 1/14; H02S 30/20; H02S 40/30; H02S 40/38

(52) U.S. Cl. CPC A47C 1/0242; A47C 1/143; H02S 40/38; H02S 30/20; H02S 40/30; A47C 1/0246

(57) ABSTRACT

An adjustable chaise lounge is provided having a generally horizontal main frame, a seat portion, and an adjustable back rest with a free end and a proximal end that is coupled to the chaise lounge. The adjustable chaise lounge uses solar panels and a solar charge converter to power a linear actuator that is moveable between a first position and a second position. The actuator is coupled to at least one support post at a first end and a base of the back rest at a second end such that when the linear actuator moves between the first position and the second position it raises and lowers the adjustable back rest.

### RELATED APPLICATION

The following application claims priority to U.S. Provisional No. 62/984,606, filed Mar. 3, 2020, which is herein incorporated by reference in its entirety.

### FIELD OF THE DISCLOSURE

The disclosure relates generally to the field of outdoor furniture. More specifically, the disclosure relates to the field of solar-powered poolside chaise lounges.

### SUMMARY

The following presents a simplified summary of the disclosure in order to provide a basic understanding of some aspects of the disclosure. This summary is not an extensive overview of the disclosure. It is not intended to identify critical elements of the disclosure or to delineate the scope of the disclosure. Its sole purpose is to present some concepts of the disclosure in a simplified form as a prelude to the more detailed description that is presented elsewhere.

In one embodiment, an adjustable chaise lounge has a generally horizontal main frame having a top, a bottom, and two sides, as well as a seat portion and an adjustable back rest having a free distal end and a proximal end that is coupled to the chaise lounge. The back rest has a resting surface and a base. The free end of the adjustable back rest is proximate the top of the main frame when in a fully lowered position. The chaise lounge also has at least one arm rest and at least one ground engaging member coupled to the frame. The chaise lounge has solar panels and a solar charge converter. A powered linear actuator is coupled to the main frame. The actuator is powered by the solar power converter and moveable between a first position proximate the top of the main frame and a second position proximate the seat portion. The linear actuator is moveable in a y-plane. The chaise lounge has at least one support post coupled to the actuator at a first end and coupled to the base of the adjustable back rest at a second end. When the linear actuator moves between the first position and the second position, the adjustable back rest is raised and lowered. The chaise lounge also has a switch coupled to the actuator and proximate the arm rest for controlling the powered movement of the actuator.

### BRIEF DESCRIPTION OF THE SEVERAL VIEWS OF THE DRAWINGS

Illustrative embodiments of the present disclosure are described in detail below with reference to the attached drawing figures and wherein:

FIG. 1 is a perspective view of a chaise lounge from above wherein a back rest is raised;

FIG. 2 is a rear view of the chaise lounge of FIG. 1 depicting the actuator and a base of the back rest;

FIG. 3 is a rear perspective view of the chaise lounge of FIG. 1;

FIG. 4 is a side view of the chaise lounge of FIG. 1; and

FIG. 5 is another side view of the chaise lounge of FIG. 1.

### DETAILED DESCRIPTION

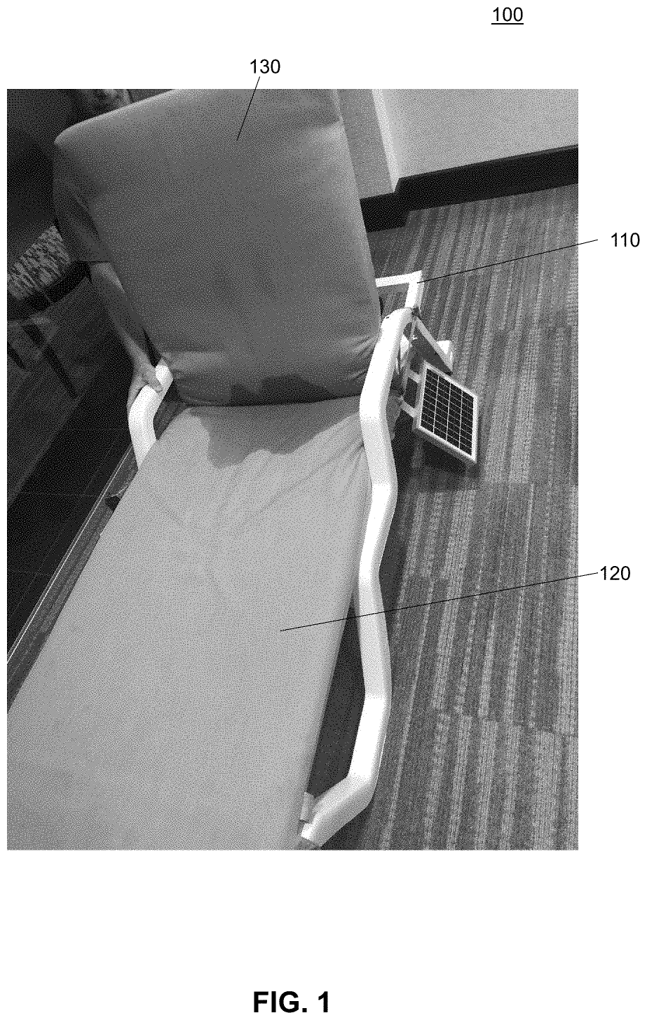

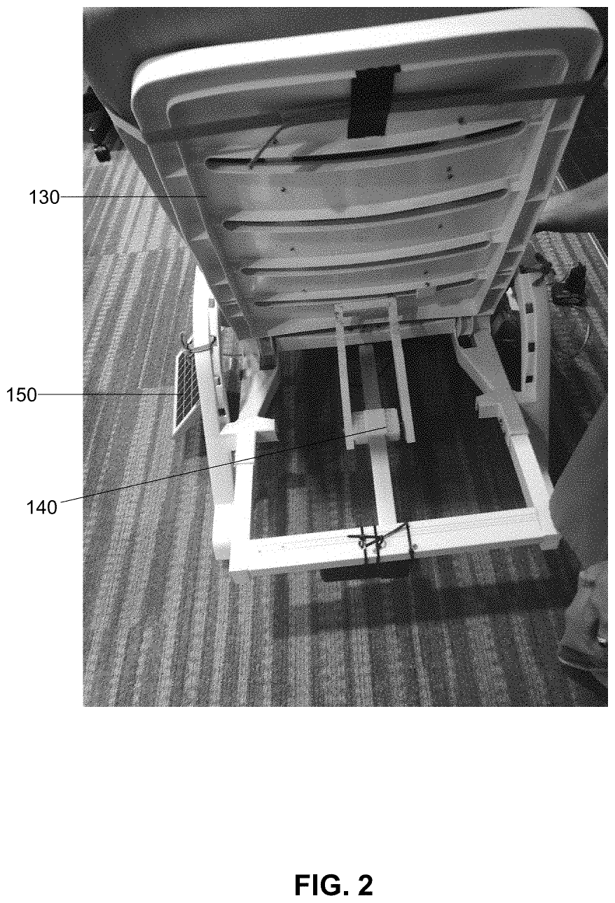

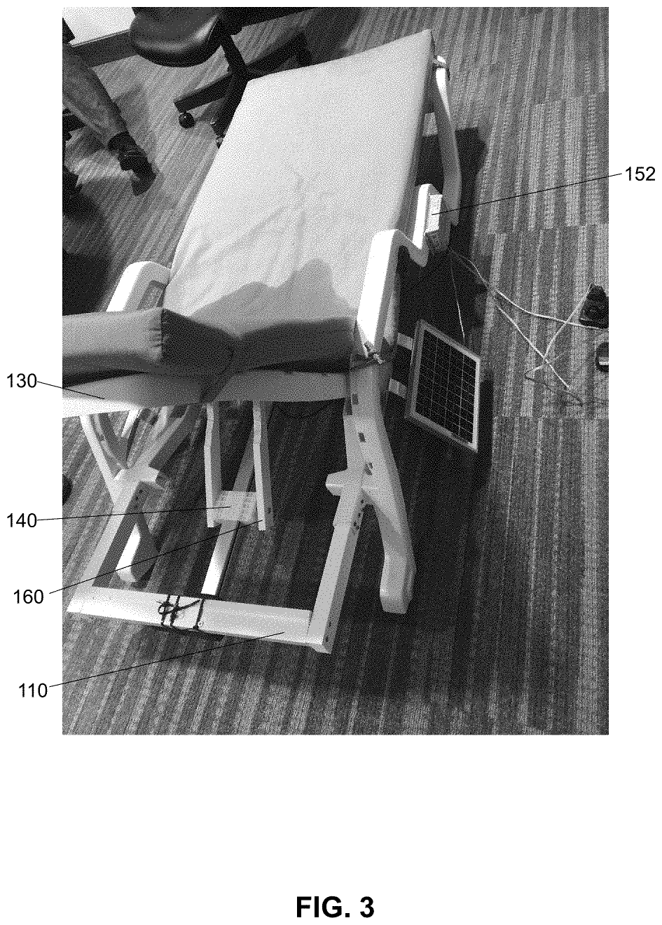

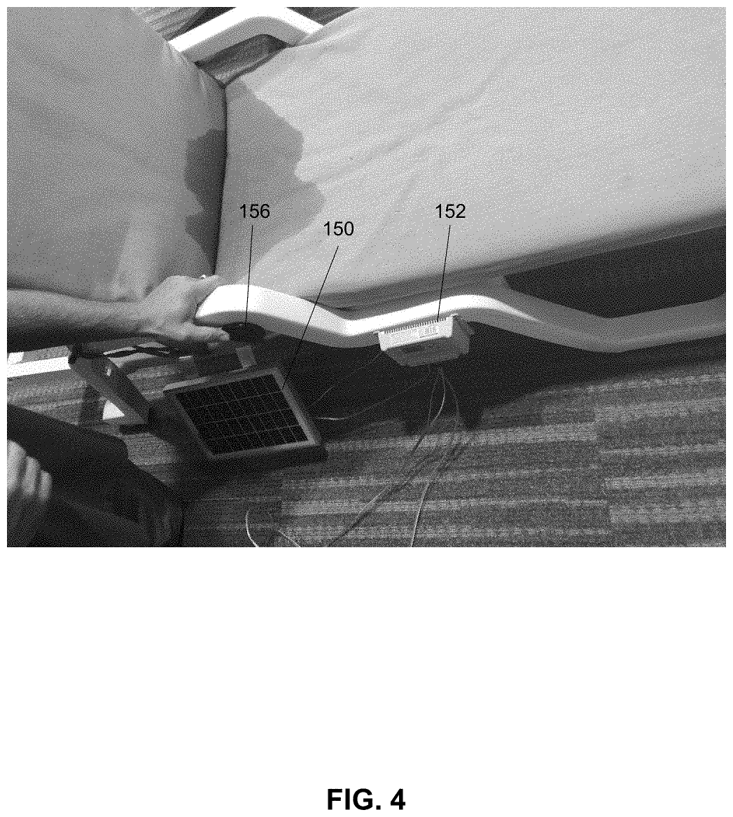

FIGS. 1 through 5 show, in part, a chaise lounge 100 according to one embodiment of the current invention. As shown in FIG. 1, a chaise lounge 100 may have a main frame 110, a seat portion 120, and an adjustable back rest 130. As is shown in FIG. 2, the back rest 130 may be raised and lowered using a powered linear actuator 140. The actuator 140 may be powered by solar power by using solar panels 150 to convert light to electricity using a solar charge converter 152. Shown in FIG. 3, the actuator 140 may be coupled to at least one support post 160. The actuator 140 and the support post 160 may raise and lower the back rest 130. In some embodiments, the linear actuator 140 is moveable in a y-plane in a horizontal path.

The chaise lounge 100 may be constructed of plastic, PVC, metal, aluminum, metal alloys, or any appropriate material now known or later discovered. The chaise lounge 100 may be configured to be regularly exposed to the elements. Further, the chaise lounge 100 may be waterproof. In some embodiments, the chaise lounge 100 may be designed to be used proximate a body of water, such as a lake, ocean, or pool.

The main frame 110 may be generally horizontal. In some embodiments, the main frame 110 may be generally rectangular. The main frame 110 may be of unitary construction. The main frame 110 may have a top end, a bottom end, and two lateral sides. The top end and bottom end may be generally parallel to one another, and the two lateral sides may be generally parallel to one another. The top end may be proximate to a user's upper body when the chaise lounge 100 is in use. In some embodiments, the main frame 110 may be rectangular and may have at least one support beam (not shown) extending between the lateral sides. The support beam may be substantially perpendicular to the lateral sides.

In some embodiments, the main frame 110 may have rounded corners. In yet other embodiments, the lateral sides may be substantially similar to one another. In some embodiments, the lateral sides may extend towards a central area. In yet other embodiments, the lateral sides may extend away from a central area of the main frame 110. A width between the lateral sides may be less than a width of the top end. Alternately, the width between the lateral sides may be greater than the width of the top end.

The seat portion 120 may have a free end, a superior end, and two lateral sides. The free end may be proximate the bottom end of the main frame 110. The seat portion 120 may extend from the bottom end of the main frame 110 toward the top of the main frame 110. The superior end of the seat portion may abut the adjustable back rest 130. The superior end may be substantially similar to the free end. In some embodiments, the superior end and the free end are generally parallel to one another. When in use, the seat portion may support at least a portion of a user's lower body.

The seat portion 120 may be integrated with the main frame 110. In some embodiments, the seat portion 120 and a portion of the main frame 110 are indistinguishable. In other embodiments, the seat portion 120 may be vertically above the main frame 110. In other embodiments, the main frame 110 may surround the seat portion 120. As noted with the main frame 110 above, the seat portion may have at least one support beam (not shown) extending between the lateral sides of the seat portion.

The adjustable back rest 130 may have a distal free end. The back rest 130 may be adjustable along an arc. In some embodiments, the back rest may be generally horizontal in a fully lowered position. Alternately, the distal end may be angled slightly downwardly in a fully lowered position. The back rest 130 may also be adjustable to a raised position. In some embodiments, the back rest 130 may be generally vertical position. When the back rest 130 is in a lowered horizontal position, the distal end may be proximate a top end of the main frame.

The back rest 130 may be adjustable at many angles as the back rest alternates lowered to raised. In contrast, prior art adjustable lounge chairs may have grooves to facilitate placement and the locking in of a post to secure the back rest 130 in an adjustable position. Such lounge chairs provided a set number of adjustable positions, typically fewer than five. The adjustable back rest 130 in the present invention can be adjusted at any angle between horizontal and vertical.

The adjustable back rest 130 may further have two lateral sides and a proximal end that extends from the distal end towards the bottom of the main frame 110. In some embodiments, the proximal end is hingedly connected to the chaise 100. In some embodiments, the proximal end is hingedly connected to the lateral sides of the main frame 110. The proximal end may abut the superior end of the seat portion 120. In some embodiments, the proximal end is hingedly connected to the seat portion 120.

The adjustable back rest 130 may also have a base and a resting surface. When in use, a user's upper body may interact with the resting surface. A portion of the base may rest on top of the main frame 110.

The adjustable chaise lounge 100 may also have a powered linear actuator 140. The linear actuator 140 may be powered by solar power. As is shown in FIG. 3, solar panels 150 may capture solar energy, a battery (not shown) may store the energy, a switch 156 may send signals to move the actuator 140, and a solar charge converter 152 may convert the solar energy captured by the solar panels 150 into electricity for use by the linear actuator 140.

The linear actuator 140 may be coupled to the main frame 110. The main frame 110 may have a track between the lateral sides. The track may be coupled to the top end of the main frame 110. The track may be substantially parallel the lateral sides. In some embodiments, the track may be coupled to the top end and the bottom end of the main frame 110. In some embodiments, the track may be medially between the lateral sides. The track may be substantially horizontal. The track may be configured such that the linear actuator is moveable along the track from a first position to a second position. In some embodiments the track may have a length between 12 inches and 36 inches. In some embodiments, the track may have a length of 18 inches.

At least one support post 160 may be coupled to the linear actuator 140 at a first end and the base of the back rest 130 at a second end. In some embodiments, the support post 160 may be hingedly connected to the linear actuator 140. In other embodiments, the support post 160 may be hingedly connected to the base of the back rest 130. In still other embodiments, the support post 160 may hingedly connected, or connected in any other appropriate manner now known or later discovered. In some embodiments, the support post 160 does not have a variable length.

There may be multiple support posts 160, as is shown in FIG. 2. In one embodiment, two support posts 160 are used. The support posts 160 may be coupled proximate a central area of the base of the back rest 130. This may lead to increased stability and support. Coupling the support post 160 to the base of the back rest 130 may provide optimal torque and movement for raising and lowering the back rest 130. Coupling the support post 160 to the back rest 130 may allow for optimal lift and increased stability for users of varying weights.

The linear actuator 140 may be moveable along the track in a y plane. When the linear actuator 140 moves along the track, the support post 160 may push the base of the back rest 130 upward to an upright vertical position. Alternately, the linear actuator 140 may lower the base of the back rest 130 toward a horizontal position. Therefore, the movement of the linear actuator may correspond with raising and lowering the back rest. The first position of the linear actuator 140 on the track may correspond to a lowered back rest, and a second position of the linear actuator 140 on the track may correspond to a raised back rest.

In some embodiments the back rest 130 may be raised and lowered using a horizontal screw drive mechanism. In other embodiments, the back rest 130 may be lowered without using a telescoping mechanism. In other embodiments, the back rest 130 may be raised and lowered without using a hydraulic mechanism. There may be no fluids used to drive the back rest 130.

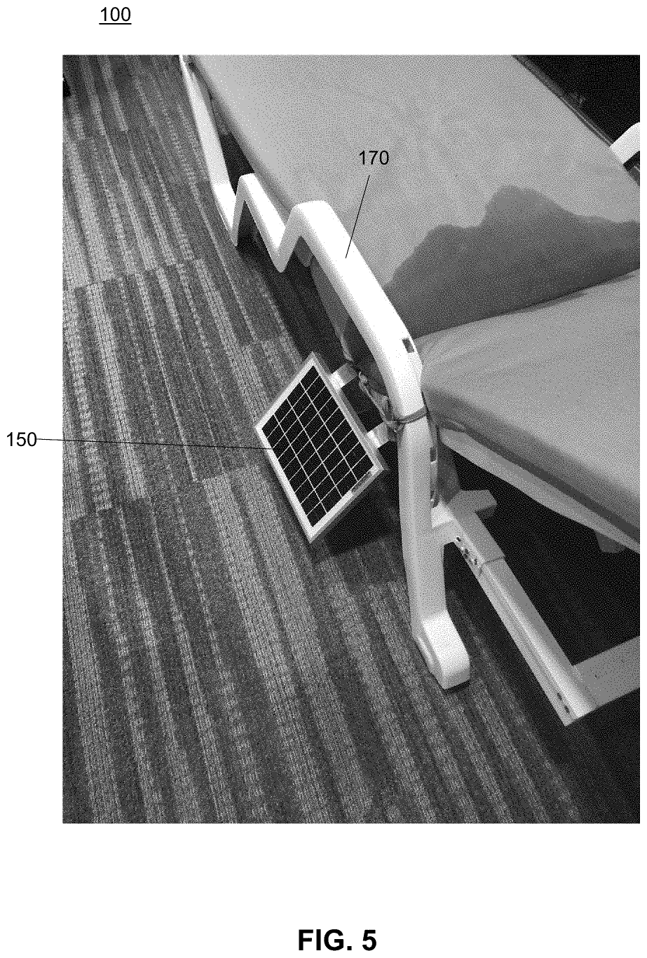

As shown in FIG. 5, the adjustable chaise lounge 100 may have at least one arm rest 170. The arm rest 170 may be proximate a middle area between the top end and the bottom end of the main frame 110. In some embodiments, the arm rest 170 may be coupled to the main frame 110. The solar panels 150 may be coupled to the arm rest 170. In some embodiments, there may be two arm rests 170 and solar panels 150 may be coupled proximate both arm rests 170. The switch 156 may also be positioned proximate the arm rest 170 for optimal access by a user. In the prior art chaise lounges, a user may need to exit the chaise lounge 100 and manually adjust the back rest 130. In the present invention, a user may not need to exit the chaise lounge and may be able to adjust the back rest 130 while still reclining on the lounge 100.

The chaise lounge 100 may include a ground engaging member 180 coupled to the frame 110. The ground engaging member 180 may lift the frame 110 such that a user is elevated and lounging above the ground. The ground engaging member 180 may take any appropriate form now known or later developed. In one embodiment, the ground engaging member 180 may have two legs that are vertically below the main frame 110. In other embodiments the ground engaging member 180 may be integrated with the main frame 110. In some embodiments, the ground engaging member 180 may not have feet at the bottom end of the frame 110.

The chaise lounge 100 may also include cushions configured to be placed atop the resting surface of the adjustable back rest 130 and atop the seat portion 120. Alternately, the chaise lounge may have material extending between the lateral sides of the seat portion 120 that support a weight of a user when a user is reclining. In some embodiments, the material may be fabric.

The chaise lounge 100 may include a sun visor. In some embodiments, the sun visor may be powered. The sun visor may be raised and lowered to shade a user or protect a user from the elements. The sun visor may be variable between a retracted position and an extended position. In some embodiments, the sun visor is proximate a distal end of the back rest 130 when in a fully retracted position. In the extended position, the sun visor may cover the back rest 130 and at least a portion of the seat portion 120.

The chaise lounge 100 may also include a fan (not shown) for cooling and ventilation. The fan may be powered by solar power. Alternately, the fan may be powered by any other means known in the art, such as by a battery or electrical grid. In some embodiments, the fan may be placed behind the back rest 130. The fan may be coupled to the frame and may be adjustable. In some embodiments, the chaise lounge 100 may include two fans. In addition to a fan coupled to the frame, another fan may be affixed underneath seat of the chaise lounge 100. When in use, this fan may assist in cooling a user.

In some embodiments, the chaise lounge 100 may include a USB plug so that a user may charge an electronic device. The chaise lounge 100 may also include a device to hold a cell phone. In some embodiments, the chaise lounge may include a powered fan. In other embodiments, the chaise lounge 100 may include a thermoelectric drink cooler or heater.

It is envisioned that the chaise lounge 100 and all of its various attachments may be powered by solar power. In addition to solar power, the chaise lounge 100 may have at least one alternate power source. In the event that there was insufficient sunlight, the chaise lounge 100 may use an alternate power source. The alternate power source may be any alternate power source now known or later developed, such as a DC adaptor, battery, or connection to an electrical grid.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

It is claimed:

1. An adjustable chaise lounge comprising:
a generally horizontal main frame having a top, a base, and two sides;
a seat portion;
an adjustable back rest member having a free distal end and a proximal end that is coupled to the chaise lounge, the back rest member having a resting surface and a base, the free end of the adjustable back rest being proximate the top of the main frame when in a fully lowered position;
at least one arm rest;
at least one ground engaging member coupled to the frame;
solar panels and a solar charge converter;
a powered linear actuator coupled to the main frame, wherein the actuator is powered by the solar power converter and moveable between a first position proximate the top of the main frame and a second position proximate the seat portion, the linear actuator being moveable in a y-plane;
at least one support post having coupled to the actuator at a first end and coupled to the base of the adjustable back rest at a second end, wherein when the linear actuator moves between the first position and the second position, the adjustable back rest is raised and lowered by the powered actuator; and
a switch coupled to the actuator and proximate the arm rest for controlling the powered movement of the actuator.

2. The adjustable chaise lounge of claim 1, wherein the solar panels are coupled to the armrest.

3. The adjustable chaise lounge of claim 1, further comprising a second support post.

4. The adjustable chaise lounge of claim 1, further comprising a lithium ion battery.

5. The adjustable chaise lounge of claim 1, further comprising a powered sun visor, wherein the sun visor is powered by the solar power converter and moveable between a first position and a second position.

6. The adjustable chaise lounge of claim 1, further comprising cushions for the seat portion and adjustable back rest.
